(19) United States
(12) Patent Application Publication
(10) Pub. No.: US 2021/0354645 A1
(43) Pub. Date: Nov. 18, 2021

(54) HIGH-IMPACT ENERGY ABSORPTION CONNECTION DESIGN FOR AUTO INTERIOR DISPLAY MODULE UNDER HEAD FORM IMPACT

(71) Applicant: CORNING INCORPORATED, CORNING, NY (US)

(72) Inventors: Amey Ganpat Badar, Corning, NY (US); Khaled Layouni, Fontainebleau (FR); Jong Se Park, Horseheads, NY (US); Yousef Kayed Qaroush, Painted Post, NY (US); Yang Yang, Fremont, CA (US)

(21) Appl. No.: 17/286,096

(22) PCT Filed: Oct. 14, 2019
(86) PCT No.: PCT/US2019/056026

§ 371 Date: Apr. 16, 2021

Related U.S. Application Data
(60) Provisional application No. 62/747,483, filed on Oct. 18, 2018.
(60) Provisional application No. 62/754,553, filed on Nov. 1, 2018.
(60) Provisional application No. 62/760,483, filed on Nov. 13, 2018.

(51) Int. Cl. B60R 21/00; B60K 37/04

(52) U.S. Cl. CPC B60R 21/00; B60K 2370/816; B60K 37/04

(57) ABSTRACT

A vehicle interior system is provided. The vehicle interior system includes a back structure that further includes one or more display devices for a vehicle user. A transparent cover material is attached to the back structure. The vehicle interior system includes a collapsible energy-absorbing support for attaching the back structure to a frame of the vehicle. The collapsible energy-absorbing support is configured to dissipate kinetic energy via plastic deformation. In particular embodiments, the collapsible energy-absorbing support comprises a hollow tube or a formed rectangular plate.

### CROSS-REFERENCE TO RELATED APPLICATIONS

This application claims the benefit of priority under 35 U.S.C. § 119 of U.S. Provisional Application Ser. No. 62/760,483 filed on Nov. 13, 2018 and U.S. Provisional Application Ser. No. 62/754,553 filed on Nov. 1, 2018 and U.S. Provisional Application Ser. No. 62/747,483 filed on Oct. 18, 2018, the content of which are relied upon and incorporated herein by reference in their entirety.

### TECHNICAL FIELD

The disclosure relates to vehicle interior systems including glass and methods for forming the same, and more particularly to vehicle interior systems including a cold-formed or cold-bent cover glass and having improved impact performance, and methods for forming the same.

### BACKGROUND

In the automotive industry, more and more attention has been recently drawn to the improvement of structural crashworthiness for reducing occupant fatalities and injuries. For crashworthiness, it refers to the response a vehicle when it is involved in or undergoes an impact. During the impact, severe injuries could happen if the head of driver or passenger hit the car interior structures, such as display module. Furthermore, if the cover material, which may be glass, is broken, it is very likely to cause secondary injuries from the fragments. To mitigate the injuries and save life while taking full advantage of the high strength of certain chemically strengthened glasses, such as Gorilla® Glass from Corning Incorporated, it is of great importance to find out an optimal display module design that can protect the driver and passengers under moderate impact as required in auto industry specifications.

### SUMMARY

In one aspect, embodiments of the invention provide a vehicle interior system includes a back structure that further includes one or more display devices for a vehicle user. A transparent cover material is attached to the back structure. The vehicle interior system includes a collapsible energy-absorbing support for attaching the back structure to a frame of the vehicle. The collapsible energy-absorbing support is configured to dissipate kinetic energy via plastic deformation. In particular embodiments, the collapsible energy-absorbing support comprises a hollow tube or formed plate. In one or more embodiments, the collapsible energy-absorbing support may include a spring that is attached to another support. For example, a spring may be attached to a formed plate.

In a particular embodiment, the collapsible energy-absorbing support has a first end attached to the vehicle frame and a second end attached to the back structure, and wherein the distance from the first end to the second end ranges from one centimeter to 10 centimeters. In a further embodiment of the invention, the collapsible energy-absorbing support is a hollow tube made from a ductile material, or a plate made from a ductile material, where the plate is formed into a shape that facilitates attachment to the back structure and vehicle frame. In one or more embodiments, the plate may have a rectangular shape. The collapsible energy-absorbing support may be constructed from metal. In one or more embodiments, the collapsible energy-absorbing support includes a spring attached to the plate (which may be rectangular). In one or more embodiments, the spring may have a stiffness of about 5000 KN/m or less.

The transparent cover material may be constructed from chemically strengthened glass, such as Gorilla® Glass. In some embodiments of the invention, the back structure comprises one or more of a display (e.g., liquid crystal display, organic light emitting display and the like), a touch panel, a circuit board, and a display frame.

In particular embodiments, a headform impact to the cover material, from a headform made of aluminum with a mass of 6.68 kilograms and where the headform impacts the cover material at 5.36 meters per second, results in a maximum headform deceleration of less than 90 g. Additionally, a headform impact to the cover material, from a headform made of aluminum with a mass of 6.68 kilograms and where the headform impacts the cover material at 5.36 meters per second, may also result in a maximum headform displacement of greater than 30 millimeters.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present disclosure. In the drawings:

FIG. 1 is a side view illustration of the curved glass substrate of FIG. 3 before it is curved, according to an embodiment of the invention;

FIG. 2 is a perspective view illustration of a vehicle interior with vehicle interior systems, according to one or more embodiments of the invention;

FIG. 3 shows plan views of a rectangular plate metallic energy absorber used as the connection between display back structure and car frame, in accordance with an embodiment of the invention;

FIGS. 4A and 4B show exemplary plan views of the rectangular plate metallic energy absorber of FIG. 2 as it would appear in a vehicle both before and after a vehicle collision

FIG. 5A is a plan view of a tube-shaped energy absorber with a die, constructed in accordance with an embodiment of the invention;

FIG. 5B is a plan view of a tube-shaped energy absorber under an axial compression load or the fully fixed boundary condition;

FIG. 6 shows perspective views of an exemplary tube deformation mode such as might be realized by the tube-shaped energy absorber of FIG. 3A;

FIG. 7 shows perspective views of exemplary tube deformation modes, different from that shown in FIG. 4, as might be realized by the tube-shaped energy absorber of FIG. 3A;

FIG. 8 is a graphical illustration showing a time history of a head displacement during a vehicle collision for a conventional auto interior display module;

FIG. 9 is a graphical illustration showing a time history of a head acceleration during a vehicle collision for a conventional auto interior display module;

FIG. 10 depicts the location of stress on the top surface of an exemplary glass cover from a head impact during a vehicle collision for a conventional auto interior display module;

FIG. 11 depicts the location of stress on the bottom surface of an exemplary glass cover from a head impact during a vehicle collision for a conventional auto interior display module;

FIG. 12 is a graphical illustration showing a time history of a head displacement during a vehicle collision for an auto interior display module using the rectangular plate metallic energy absorber of the type disclosed in FIG. 2, in accordance with an embodiment of the invention;

FIG. 13 is a graphical illustration showing a time history of a head acceleration during a vehicle collision for an auto interior display module using the rectangular plate metallic energy absorber of FIG. 2, in accordance with an embodiment of the invention;

FIG. 14 depicts the location of stress on the top surface of an exemplary glass cover from a head impact during a vehicle collision for an auto interior display module using the rectangular plate metallic energy absorber of the type disclosed in FIG. 2, in accordance with an embodiment of the invention; and

FIG. 15 depicts the location of stress on the bottom surface of an exemplary glass cover from a head impact during a vehicle collision for an auto interior display module using the rectangular plate metallic energy absorber of the type disclosed in FIG. 2, in accordance with an embodiment of the invention;

FIG. 16 is a perspective view of a back structure and a plurality of collapsible energy absorbing supports attached to the back structure, according to one or more embodiments of the invention;

FIG. 17 is a graphical illustration showing impactor acceleration as a function of time for Comparative Example A, and Examples B-F after impact;

FIG. 18 is a graphical illustration showing surface stress of the glass substrate of as a function of time for Comparative Example A and Examples B-F, after impact; and

FIG. 19 is a graphical illustration of impactor acceleration and surface stress as a function of spring stiffness, of Comparative Example A and Examples B-F.

While certain preferred embodiments will be disclosed hereinbelow, there is no intent to be limited to those embodiments. On the contrary, the intent is to cover all alternatives, modifications and equivalents as included within the spirit and scope of the disclosure as defined by the appended claims.

### DETAILED DESCRIPTION

Reference will now be made in detail to various embodiments, examples of which are illustrated in the accompanying drawings. In general, a vehicle interior system may include a variety of different flat and curved surfaces that are designed to be transparent. Forming such vehicle surfaces from a glass material may provide a number of advantages compared to the typical plastic panels that are conventionally found in vehicle interiors. For example, glass is typically considered to provide enhanced functionality and user experience for many cover material applications, such as display applications and touch screen applications, compared to plastic cover materials.

While glass provides these benefits, glass surfaces in vehicle interiors should also meet performance criteria for both passenger safety and ease of use. For example, certain regulations (e.g., ECE R 21 & FMVSS201) require vehicle interiors to pass the Headform Impact Test (HIT). The HIT involves subjecting a vehicle interior component, such as a display, to an impact from a mass under certain specific conditions. The mass used is an anthropomorphic headform. The HIT is intended to simulate the impact of the head of a driver or passenger against the vehicle interior component. The criteria for passing the test include the force of the deceleration of the headform not exceeding 80 g (g-force) for longer than a 3-millisecond (ms) period, and the peak deceleration of the headform being less than 120 g. As used in the context of the HIT, “deceleration” refers to the deceleration of the headform as it is stopped by the vehicle interior component.

Beside these regulatory requirements, there are additional concerns when using glass under these conditions. For example, it may be desirable for the glass to remain intact and not fracture when subjected to the impact from the HIT. In some case, it may be acceptable for the glass to fracture, but the fractured glass should behave in a way to reduce the chance of causing lacerations on a real human head. In the HIT, laceration potential can be simulated by wrapping the headform in a substitute material representing human skin, such as a fabric, leather, or other material. In this way, laceration potential can be estimated based on the tears or holes formed in the substitute material. Thus, in the case where the glass fractures, it may be desirable to decrease the chance of laceration by controlling how the glass fractures.

The foregoing requirements are present when the cover material is glass or plastic or in a flat configuration or curved configuration. In curved configurations, cover material may be formed by a hot-bending process or a cold-bending process. The material for the cover glass can play a factor in HIT performance. Soda-lime glass, for example, can fracture as a result of the HIT, and thus could cause lacerations. Plastic may not fracture or lacerate, but it scratches easily and degrades the quality of displays.

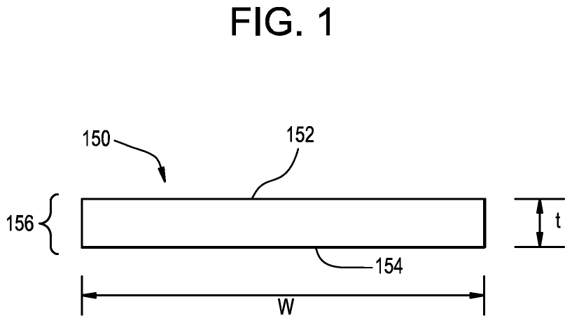

Referring to FIG. 1, the glass substrate 150 includes a first major surface 152 and a second major surface 154 opposite the first major surface. A minor surface 156 connects the first major surface 152 and the second major surface 154, where a thickness t of the glass substrate 150 is defined as the distance between the first major surface 152 and the second major surface 154. As used herein, the term “glass substrate” is used in its broadest sense to include any object made wholly or partly of glass. Glass substrates include laminates of glass and non-glass materials, laminates of glass and crystalline materials, and glass-ceramics (which include an amorphous phase and a crystalline phase).

In one or more embodiments, the glass substrate may be strengthened. In one or more embodiments, the glass substrate may be strengthened to include compressive stress (CS) that extends from a major surface (i.e., the first major surface 152 and/or the second major surface 154) to a depth of compression (DOC). The regions under compressive regions are balanced by a central region exhibiting a tensile stress (the central tension region or CT region). At the DOC, the stress crosses from a compressive stress to a tensile stress. The compressive stress and the tensile stress are provided herein as absolute values. A “stress profile” is a plot of stress with respect to position of a glass substrate.

When a strengthened glass substrate is utilized, the first major surface and the second major surface (152, 154) are already under compressive stress.

In one or more embodiments, the glass substrate may be strengthened mechanically by utilizing a mismatch of the coefficient of thermal expansion between portions of the article to create a compressive stress region and a central region exhibiting a tensile stress. In some embodiments, the glass substrate may be strengthened thermally by heating the glass to a temperature above the glass transition point and then rapidly quenching.

In one or more embodiments, the glass substrate may be chemically strengthening by ion exchange. In the ion exchange process, ions at or near the surface of the glass substrate are replaced by—or exchanged with—larger ions having the same valence or oxidation state. In those embodiments in which the glass substrate comprises an alkali aluminosilicate glass, ions in the surface layer of the article and the larger ions are monovalent alkali metal cations, such as Li+, Na+, K+, Rb+, and Cs+. Alternatively, monovalent cations in the surface layer may be replaced with monovalent cations other than alkali metal cations, such as Ag+ or the like. In such embodiments, the monovalent ions (or cations) exchanged into the glass substrate generate a stress.

In one or more embodiments, the glass substrate 150 is in a curved configuration. In one or more embodiments, such a curved glass substrate is a cold-bent glass substrate. As used herein, the terms “cold-bent,” “cold-bending,” “cold-formed,” or “cold-forming” refers to curving the glass substrate at a cold-form temperature which is less than the softening point of the glass (as described herein). A feature of a cold-formed glass substrate is asymmetric surface compressive between the first major surface 152 and the second major surface 154. In one or more embodiments, prior to the cold-forming process or being cold-formed, the respective compressive stresses in the first major surface 152 and the second major surface 154 of the glass substrate are substantially equal. In one or more embodiments in which the glass substrate is unstrengthened, the first major surface 152 and the second major surface 154 exhibit no appreciable compressive stress, prior to cold-forming. In one or more embodiments in which the glass substrate is strengthened (as described herein), the first major surface 152 and the second major surface 154 exhibit substantially equal compressive stress with respect to one another, prior to cold-forming.

In one or more embodiments, after cold-forming, the compressive stress on the surface having a concave shape after bending increases. In other words, the compressive stress on the concave surface is greater after cold-forming than before cold-forming. Without being bound by theory, the cold-forming process increases the compressive stress of the glass substrate being shaped to compensate for tensile stresses imparted during bending and/or forming operations. In one or more embodiments, the cold-forming process causes the concave surface to experience compressive stresses, while the surface forming a convex shape after cold-forming experiences tensile stresses. The tensile stress experienced by the convex surface following cold-forming results in a net decrease in surface compressive stress, such that the compressive stress in convex surface of a strengthened glass sheet following cold-forming is less than the compressive stress on the same surface when the glass sheet is flat.

A first aspect of the instant application pertains to a vehicle interior system. The various embodiments of the vehicle interior system may be incorporated into vehicles such as trains, automobiles (e.g., cars, trucks, buses and the like), seacraft (boats, ships, submarines, and the like), and aircraft (e.g., drones, airplanes, jets, helicopters and the like).

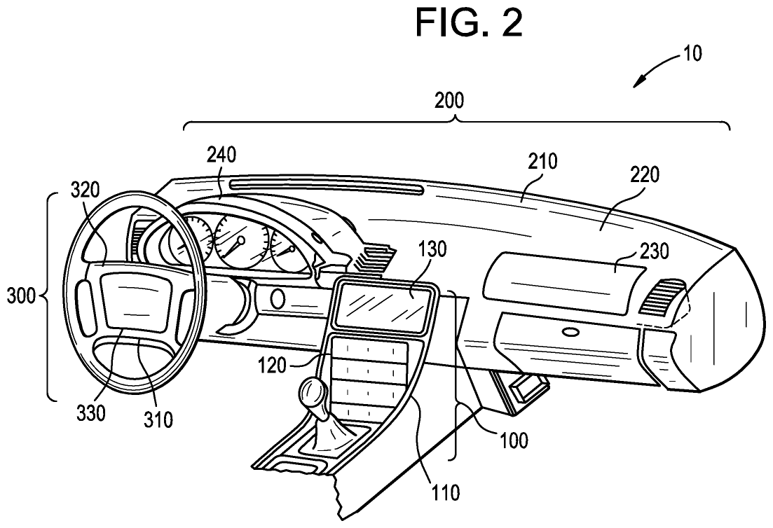

FIG. 2 illustrates an exemplary vehicle interior 10 that includes three different embodiments of a vehicle interior system 100, 200, 300. Vehicle interior system 100 includes a center console base 110 with a curved surface 120 including a curved display 130. Vehicle interior system 200 includes a dashboard base 210 with a curved surface 220 including a curved display 230, which may be made of glass or some other transparent material. The dashboard base 210 typically includes an instrument panel 215 which may also include a curved display. Vehicle interior system 300 includes a dashboard steering wheel base 310 with a curved surface 320 and a curved display 330. In one or more embodiments, the vehicle interior system may include a base that is an arm rest, a pillar, a seat back, a floor board, a headrest, a door panel, or any portion of the interior of a vehicle that includes a curved surface.

The embodiments of the curved display described herein can be used interchangeably in each of vehicle interior systems 100, 200, and 300. Further, the curved glass substrates discussed herein may be used as curved cover glasses for any of the curved display embodiments discussed herein, including for use in vehicle interior systems 100, 200, and/or 300.

Generally, examples of various vehicle interior systems, according to embodiments discussed herein, include a mechanical frame permanently attached to the vehicle. A mounting bracket or similar device may be used to attach a user-facing vehicle interior component, such as a decorative dash component or display, to the mechanical frame of the vehicle.

In terms of the structural performance under head form impact, the components in the vehicle display module are grouped into four main structures. The cover material may be a glass substrate that may be a chemically strengthened glass substrate (e.g., Gorilla® Glass), adhesives, back structure and supports. The back structure may include LCD panels, touch pads, circular boards, display frames and housings, etc. In summary, the stiffness of the back structure and supports dominates the dynamic responses of the headform and cover material stress, for example.

Embodiments of the invention disclosed herein focus on implementing several collapsible energy absorbers as the support structures (i.e., collapsible energy-absorbing supports) to connect auto interior display to the structural frame of the car. In general, an energy absorber is a system that converts, totally or partially, kinetic energy into another form of energy. The converted energy can be reversible such as elastic strain energy and/or irreversible in the form of plastic deformation. Metal is commonly used for these supports due to its high ductility, though other ductile materials may be suitable. For ductile metallic materials, the amount of elastic energy is usually much smaller compared to total plastic energy under large deformation. Thus, the plastic deformation localized in the energy absorber allows the vehicle interior system to attenuate both dynamic responses of head form impact and peak stress in a glass cover material, for example.

Conventional supports are often designed with extremely high stiffness and are even fully fixed in some cases. The result is that the applied kinetic energy is being transferred to every component, which includes non-load carrying components, in the vehicle display module and typically the amount of energy allocated to each one is proportional to the its stiffness. It turns out that the supports exert a huge reaction force due to their high stiffness. This leads to significant head deceleration and intrusion, and correspondingly to maximum principal stress in strengthened glass substrates, for example.

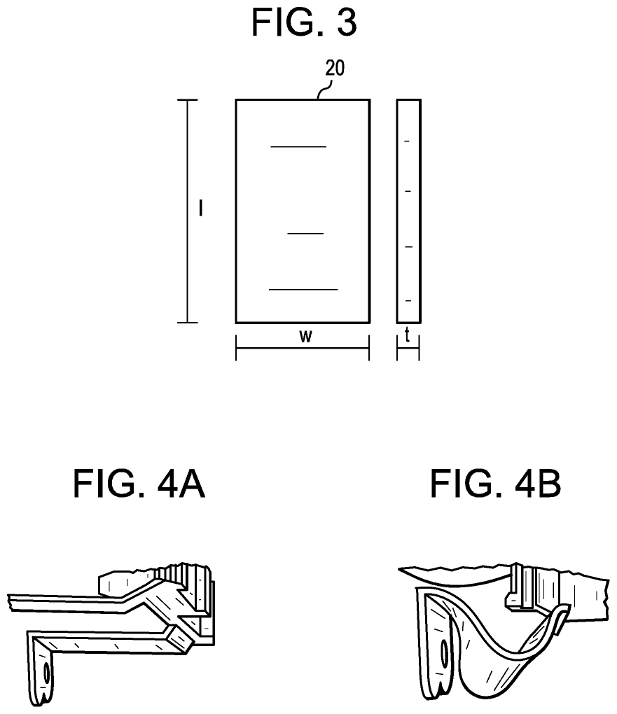

With respect to the devices disclosed herein, and illustrated in FIGS. 3-7 for the attachment of vehicle interior systems, two types of collapsible energy-absorbing supports are proposed. The first one, shown in FIG. 3, is a plate 20, which can be disposed at each support location as the collapsible energy absorber for the vehicle interior system 100, 200. The length, width and thickness are denoted as l, w and t, respectively. The idea is that under inelastic global buckling, a significant of amount plastic energy in converted. In the embodiment shown, the plate has a rectangular shape. In one or more embodiments, the plate maybe metal.

In FIG. 16, the collapsible energy-absorbing support may include a mounting mechanism (denoted schematically as a spring). In one or more embodiments, the mounting mechanism may be attached to the plate, as shown in FIG. 16. In one or more embodiments, the mounting mechanism comprises a stiffness (K) of about 5000 KN/m or less, about 1000 KN/m or less, about 500 KN/m or less, about 200 KN/m or less. In one or more embodiments, the mounting mechanism may have a stiffness in a range from about 50 KN/m to about 5000 KN/m, from about 100 KN/m to about 5000 KN/m, from about 150 KN/m to about 5000 KN/m, from about 200 KN/m to about 5000 KN/m, from about 250 KN/m to about 5000 KN/m, from about 300 KN/m to about 5000 KN/m, from about 350 KN/m to about 5000 KN/m, from about 400 KN/m to about 5000 KN/m, from about 450 KN/m to about 5000 KN/m, from about 500 KN/m to about 5000 KN/m, from about 600 KN/m to about 5000 KN/m, from about 700 KN/m to about 5000 KN/m, from about 800 KN/m to about 5000 KN/m, from about 900 KN/m to about 5000 KN/m, from about 1000 KN/m to about 5000 KN/m, from about 1500 KN/m to about 5000 KN/m, from about 2000 KN/m to about 5000 KN/m, from about 2500 KN/m to about 5000 KN/m, from about 3000 KN/m to about 5000 KN/m, from about 3500 KN/m to about 5000 KN/m, from about 4000 KN/m to about 5000 KN/m, from about 50 KN/m to about 4750 KN/m, from about 50 KN/m to about 4500 KN/m, from about 50 KN/m to about 4250 KN/m, from about 50 KN/m to about 4000 KN/m, from about 50 KN/m to about 3750 KN/m, from about 50 KN/m to about 3500 KN/m, from about 50 KN/m to about 3250 KN/m, from about 50 KN/m to about 3000 KN/m, from about 50 KN/m to about 2750 KN/m, from about 50 KN/m to about 2500 KN/m, from about 50 KN/m to about 2250 KN/m, from about 50 KN/m to about 2000 KN/m, from about 50 KN/m to about 1750 KN/m, from about 50 KN/m to about 1500 KN/m, from about 50 KN/m to about 1250 KN/m, or from about 50 KN/m to about 1000 KN/m. In embodiments, the mounting mechanism is at least one of a spring (e.g., coil spring, leaf spring, v-spring, etc.), foam (e.g., metallic, ceramic, polymeric, etc.), mounting rail, etc.

Theoretically, the maximum impact force for the case with two fixed ends can be calculated using Eq. 1,

$${F}_{max} = \frac{{Π}^{2} EI}{{( 0.5 l )}^{2}}$$

where E is the modulus of elasticity, I is the moment of area, and l is the length of the rectangular metal plate.

Equation 1 provides an upper bound for maximum load capacity. In practice, the value is much lower when inelastic buckling or plastic yielding occurs, especially when imperfections and residual stresses are considered. In this case, numerical simulation is often used to predict the critical load and post buckling strength.

Traditionally, the ratio of elastic energy to plastic energy in the supports are much larger and it ends up with very high resistant force. For the new design under head form impact, the plate 20 or plate and spring combination 50 (FIG. 16) is supposed to collapse progressively and experience large plastic deformation. A large portion of the impact kinetic energy will be absorbed in this manner.

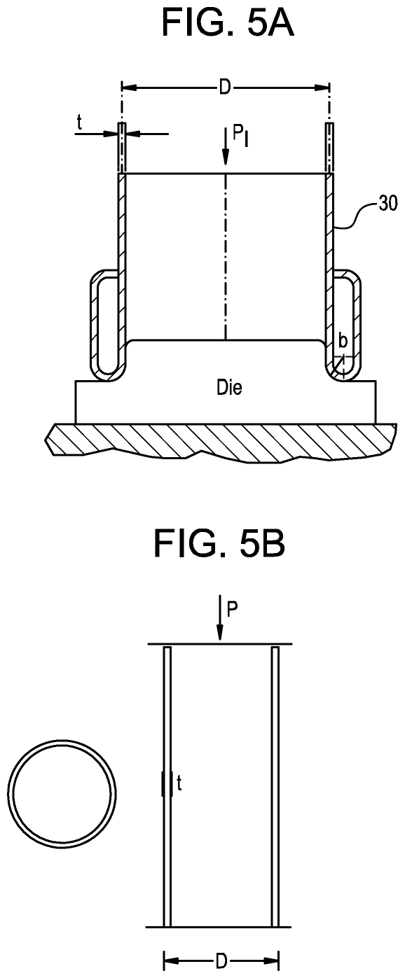

As an alternative and as shown in FIGS. 5A and 5B, it is also proposed to use closed-section thin-wall structure as the collapsible energy absorbers due to its outstanding performance under axial compression impact force. It is envisioned that several types of collapsible impact energy absorbers may be suitable as the energy absorbing supports in the present invention. Some of the shapes envisioned include tubes, frusto-conical, multi-corner columns, structs, sandwich plates, honeycomb cells, etc.

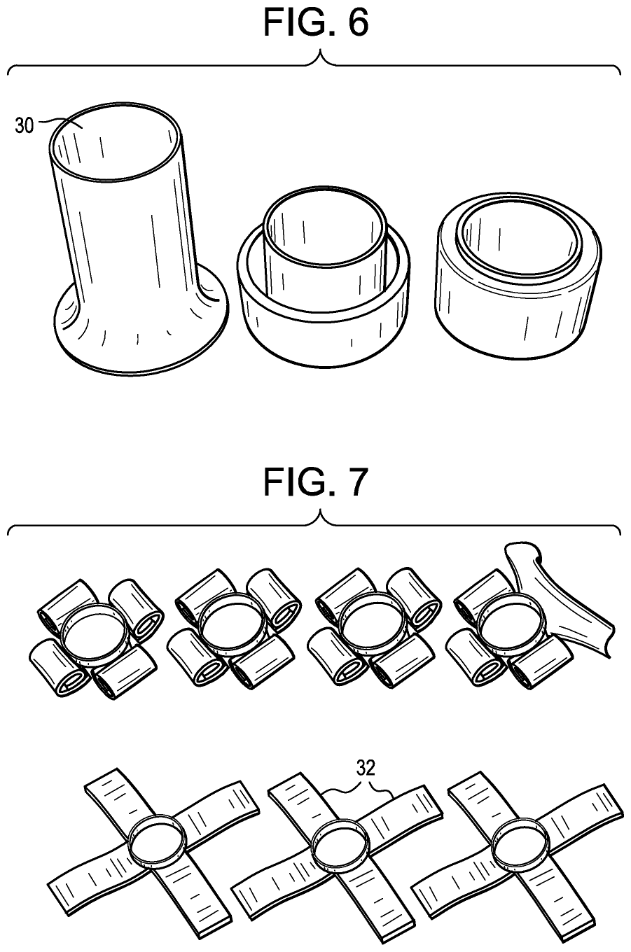

Because of their suitability as energy-absorbing as structural elements, and their ability to dissipate large amounts of kinetic energy, hollow tubes 30 are considered to work well as the energy-absorbing support for attaching the back structure to a frame of the vehicle in the present invention. Therefore, it is proposed to use the tube shape 30, a circular cross-section with thin wall thickness, to absorb the impact energy during head form impact. A typical tube 30 in accordance with embodiments of the invention is illustrated in FIGS. 5A and 6.

Plastic energy can be dissipated in thin metallic tubes 30 in several modes of deformation are shown in FIG. 7, such as tube inversion, tube splitting and axial crushing under axial compression. For tube inversion, it basically involves the turning inside out or outside in of a thin circular tube 30 made of ductile material as shown in FIG. 7. One of the advantages of tube inversion is that a constant tube inversion force can be achieved for a uniform tube 30. Because of the high constant tube inversion force, much kinetic energy is dissipated via plastic deformation of the tubes 30. It should be noted that tube inversion happens when the die radius is relatively small. If the die radius is large, another mechanism called tube-splitting occurs (see FIG. 7). In tube-splitting, the absorbed energy is dissipated in tearing of the metal of the tube into strips 32.

The most important deformation mode is called axial crushing. In the literature, it is found that circular tubes 30 under axial compression provide one of the best devices. This prominent property perhaps explains why these devices are able to dissipate large amounts of kinetic energy as used components in the present invention. The circular tube 30 proves to be an effective collapsible energy absorbing support because it provides a reasonably constant operating force, which is, in some applications, a prime characteristic of the energy absorber. Under axial loading, the tube 30 can be ensured that all of its material participates in the absorption of energy by plastic deformation. Optimal energy absorption is obtained through progressive plastic buckling which avoids overall elastic buckling. This is an advantageous feature of the hollow tubes 30 as compared to the rectangular thin plate which typically collapsed through global buckling.

The transition of axially crushed tubes from Euler (global) bending mode to progressive buckling mode at static and dynamic loading conditions has been studied by Abramowicz and Jones, “Transition from initial global bending to progressive buckling of tubes loaded statically and dynamically,” International Journal of Impact Engineering 19, no. 5-6 (1997): 415-437, which is incorporated by reference herein in its entirety. For thick cylinders D/t<80, it buckles in concertina (axisymmetric) mode of deformation, whereas thin cylinders buckle in the diamond (non-axisymmetric) mode. The average crushing force (Pₐᵥ) for concertina mode is expressed in Eq. 2,

Pₐᵥ=6Yt(Dt)^{1/2}

where Y stands for yield strength, D stands for the mean diameter of the tube (e.g., as shown in FIGS. 5A and 5B), and t stands for the wall thickness of the tube (e.g., as shown in FIGS. 5A and 5B).

The theoretical estimate of the mean axial load for diamond mode is given in Eq. 3.

Pₐᵥ=Yt(10.05t+0.38D)

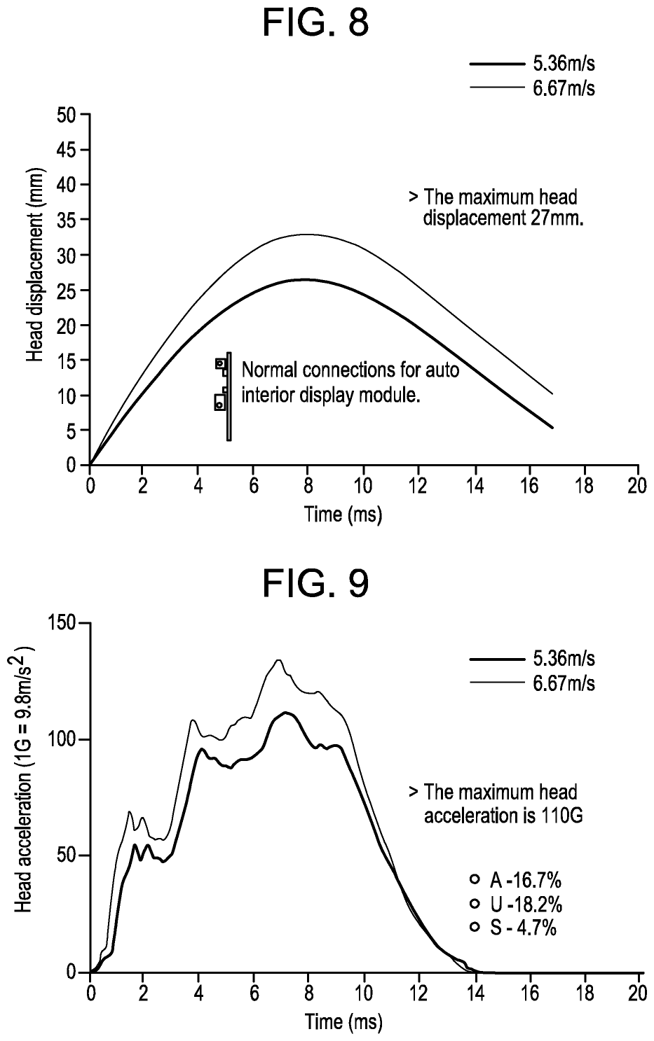

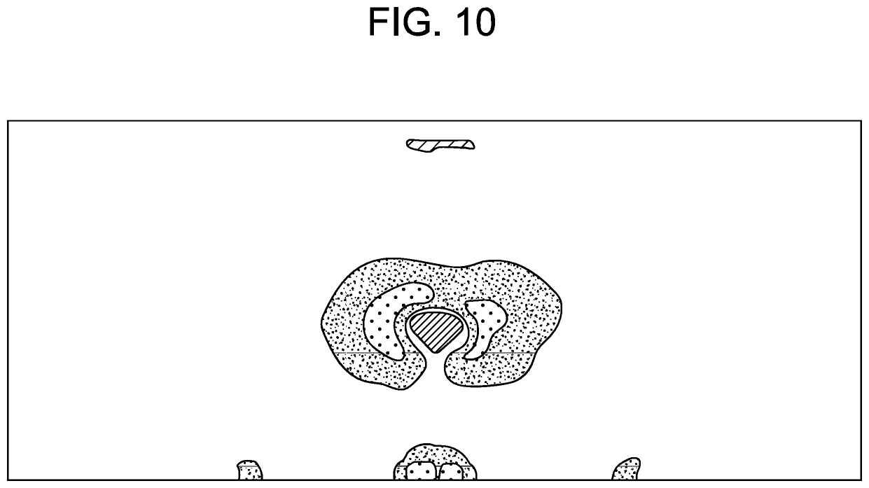

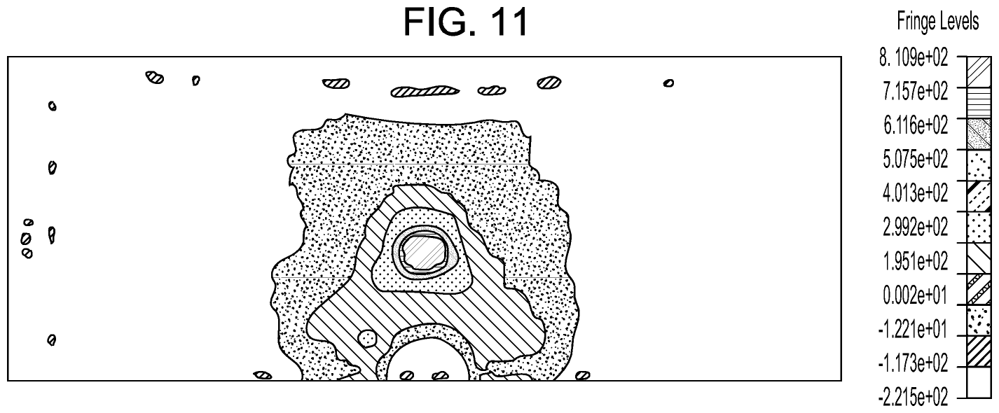

Next, numerical simulation is carried out to investigate the performance of normal connections and collapsible energy absorbers. The results are shown in the graphical illustrations of FIGS. 8 and 9. The solid head form is made of aluminum and the effective mass is 6.68 kg. The impact velocity is 6.67 meters per second (m/s) and it corresponds to a total of 152 joules of kinetic energy. As shown in FIGS. 8 and 9, tests were also conducted where the headform impact velocity was 5.36 m/s. During impact, the kinetic energy will be dissipated by different means or mechanisms. It is seen from FIGS. 8 and 9 that the maximum head deceleration is 110 G (shown in FIGS. 8 and 9 as “acceleration”) and the peak displacement or intrusion is 27 mm. These results indicate that the system is “too stiff” such that, in a collision, a vehicle passenger could experience serious injury. The maximum principal stress in S2 of Gorilla® Glass is about 820 MPa (shown in FIGS. 10 and 11), which does not guarantee a small possibility of failure.

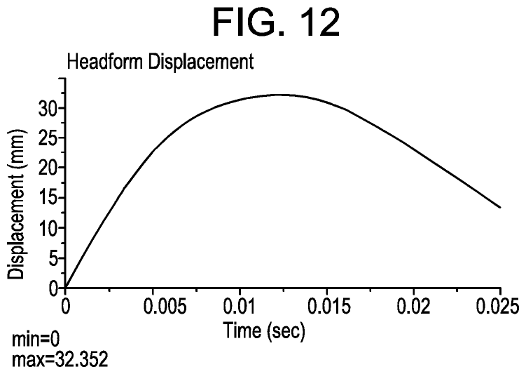

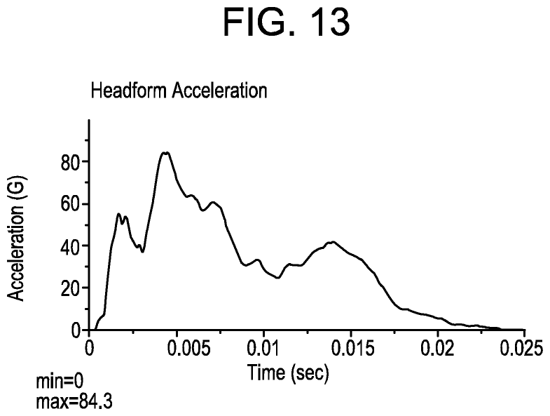

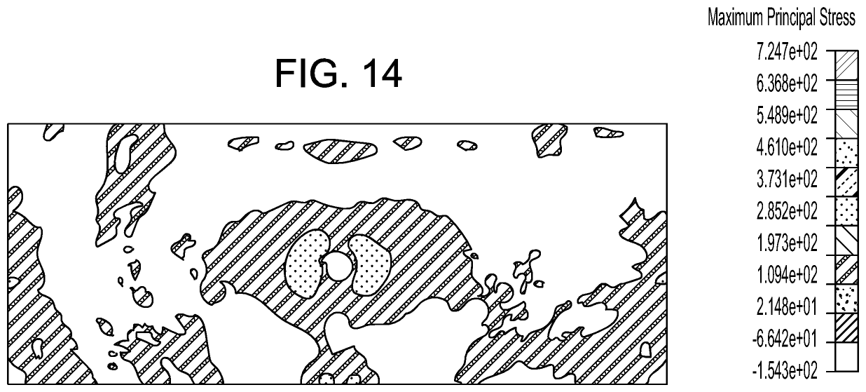

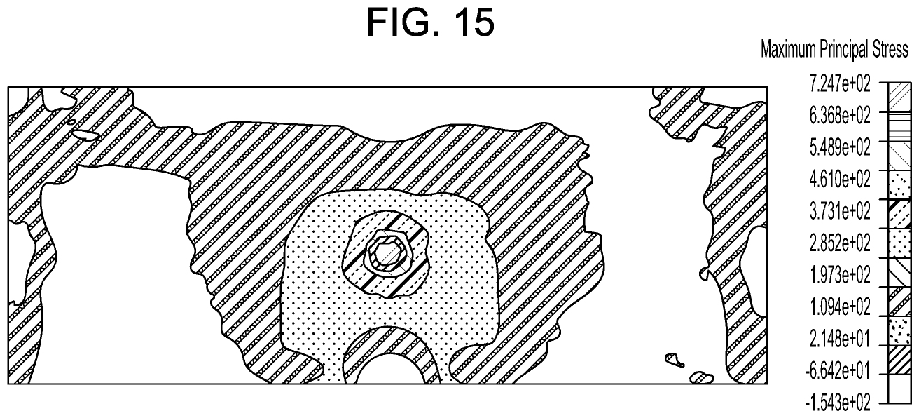

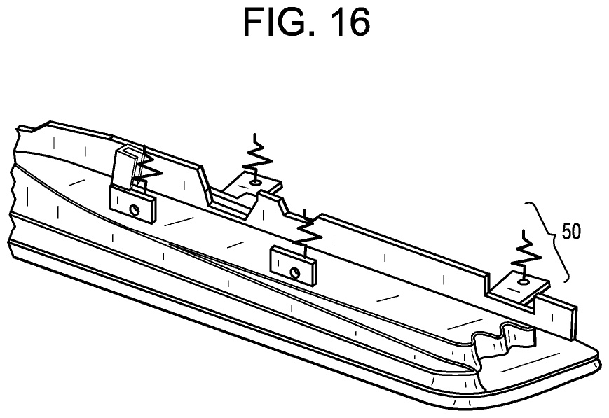

In a particular embodiment of the invention, to mitigate the headform response and reduce stress in the cover material, e.g., the Gorilla® Glass stress, the proposed metal plate 20 of FIG. 3 is used. The deformation mode is shown in FIG. 4B. The only difference from the normal connection is the length of the tabs and it is extended by 2 cm. It can be seen from FIG. 4B that buckling occurs and extensive plastic deformation is observed. Not surprisingly, the dynamic response and Gorilla® Glass stress are much smaller in this case. The results are shown in the graphical illustrations of FIGS. 12 and 13. The peak deceleration (shown in FIGS. 12 and 13 as “acceleration”) is lower down to 84 g and maximum head displacement is increased to 32 mm. The tensile stress in Gorilla® Glass has reduced to 725 MPa (shown in FIGS. 14 and 15), which is related to a very small failure probability. By contrast, in the present invention, it was found that the energy absorption of the vehicle interior system is much superior when compared to conventional vehicle interior system designs which tend to maximize support stiffness.

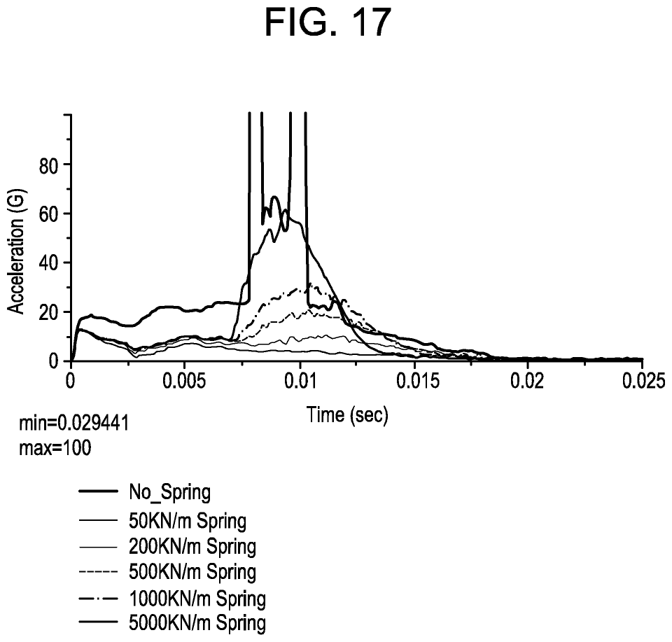

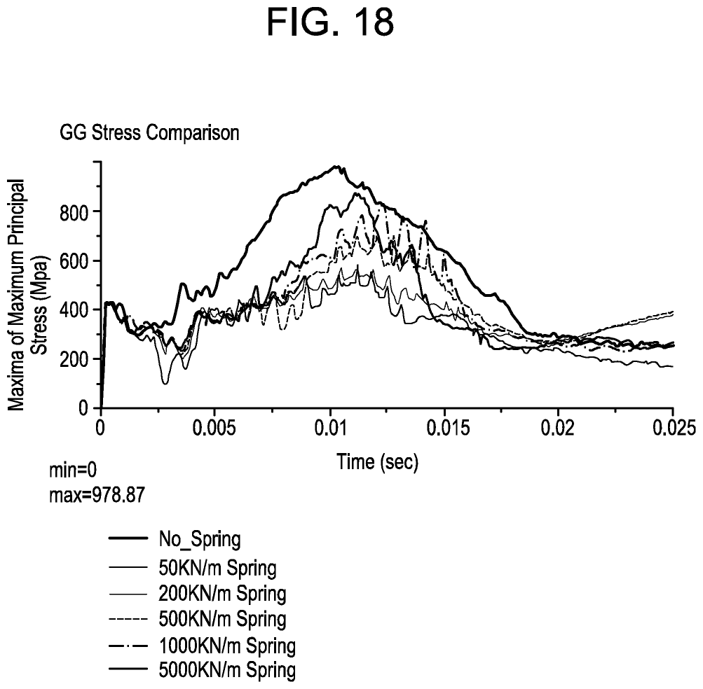

A strengthened glass substrate and back structure without a collapsible energy absorbing support (Comparative Example A) and a strengthened glass substrate and back structure with various embodiments of a collapsible energy absorbing support attached to back structure opposite the cover material. The glass substrates and back structure were identical. As shown in FIG. 16, the collapsible energy absorbing support is the plate and mounting mechanism combination 50. In embodiments, the support and mounting mechanism provide a connection between the back structure and mechanical vehicle from of from 50 kN/m to 5000 kN/m. FIGS. 17 and 18 depict headform acceleration and maximum stress on the covering material for backstructure having a collapsible support and mounting mechanism with a stiffness of 50 KN/m (Example B), a stiffness of 200 KN/m (Example C), a stiffness of 500 KN/m (Example D), a stiffness of 1000 KN/m (Example E), and a stiffness of 5000 KN/m (Example F). Specifically, FIG. 17 shows the acceleration (G) of an headform impactor impacting the first major surface opposing of the cover material as shown as a function of time (seconds) after impact. As shown in FIG. 17, Comparative Example A shows greater than 80 G acceleration. Examples B-F all show significantly reduced acceleration. In embodiments, the acceleration of the headform is no more than 90 g for a headform having a weight of 6.68 kg and striking the cover material at 5.36 meters per second. In further embodiments and under the same conditions, the acceleration of the headform is no more than 80 g, and in still further embodiments and under the same conditions, the acceleration of the headform is no more than 70 g.

As shown in FIG. 18, the stress ( MPa) on the major surface of the strengthened glass substrate adjacent the back structure (opposite the major surface being impacted by the impactor) was measured as a function of time (seconds). As shown in FIG. 18, Comparative Example A shows significantly greater surface stress on the major surface adjacent the back structure. Examples B-F exhibited significantly lower surfaces stress. In particular, all of Examples B-F had maximum surface stresses of less than 900 MPa, while Comparative Example A had a maximum surface stress of about 980 MPa. In embodiments, the surface stress on the cover material is no more than 900 MPa for a headform having a weight of 6.68 kg and striking the cover material at 5.36 meters per second. In further embodiments and under the same conditions, the surface stress on the cover material is no more than 850 MPa, and in still further embodiments and under the same conditions, the surface stress on the cover material is no more than 800 MPa.

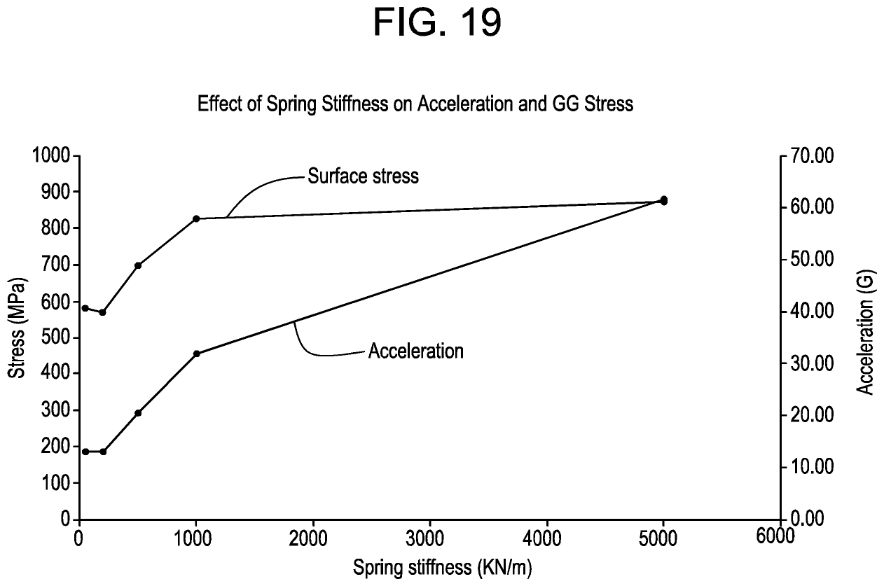

FIG. 19 shows the effect of spring stiffness on the acceleration and surface stress shown in FIGS. 16 and 17, respectively. As shown, spring stiffness in a range of about 50 KN/m to about 5000 KN/m provides lower surface stress and lower acceleration.

In view of the foregoing remarks, it can be seen that using collapsible energy absorbing support as the supports or connections for a vehicle interior display module will help convert the kinetic energy from an impactor, e.g., a headform, to plastic deformation localized in the energy absorbers. From the comparison of a normal connection to a rectangular thin plate collapsible energy absorber, it is clearly seen that the vehicle interior system of the present invention provides significantly improved safety features. In addition, it is emphasized that the plastic deformation of energy-absorbing support elements is a beneficial feature in the design of vehicle interior display systems such that they not only have enough elastic stiffness to fulfil the functionalities under normal use, but also can show improved results with respect to the design specifications under hit simulation.

Aspect (1) of this disclosure pertains to a vehicle interior system comprising: a back structure including one or more display devices for a vehicle user; a transparent cover material attached to the back structure; a collapsible energy-absorbing support for attaching the back structure to a frame of the vehicle, wherein the collapsible energy-absorbing support is configured to dissipate kinetic energy via plastic deformation.

Aspect (2) of this disclosure pertains to the vehicle interior system of Aspect (1), wherein the collapsible energy-absorbing support has a first end attached to the vehicle frame and a second end attached to the back structure, and wherein the distance from the first end to the second end ranges from one centimeter to 10 centimeters. 3

[symbol]

Aspect (3) of this disclosure pertains to the vehicle interior system of Aspect (2), wherein the collapsible energy-absorbing support comprises a hollow tube made from a ductile material.

Aspect (4) of this disclosure pertains to the vehicle interior system of Aspect (3), wherein the collapsible energy-absorbing support comprises a thin-walled hollow tube.

Aspect (5) of this disclosure pertains to the vehicle interior system of Aspect (2), wherein the collapsible energy-absorbing support comprises a rectangular plate made from a ductile material, wherein the rectangular is formed into a shape that facilitates attachment to the back structure and vehicle frame.

Aspect (6) of this disclosure pertains to the vehicle interior system of any one of Aspects (1) through (5), wherein the collapsible energy-absorbing support comprises a plate with a plate surface and a spring attached to the plate surface.

Aspect (7) of this disclosure pertains to the vehicle interior system of any one of Aspects (1) through (6), wherein the collapsible energy-absorbing support is made from metal.

Aspect (8) of this disclosure pertains to the vehicle interior system of any one of Aspects (1) through (7), wherein the transparent cover material comprises a glass substrate.

Aspect (9) of this disclosure pertains to the vehicle interior system of Aspect (8), wherein the glass substrate is strengthened.

Aspect (10) of this disclosure pertains to the vehicle interior system of any one of Aspects (1) through (9), wherein the back structure comprises one of a display, a touch panel, a circuit board, and a display frame.

Aspect (11) of this disclosure pertains to the vehicle interior system of any one of Aspects (1) through (10), wherein a headform impact to the cover material, from a headform made of aluminum with a mass of 6.68 kilograms and where the headform impacts the cover material at 5.36 meters per second, results in a maximum headform deceleration of less than 90 g.

Aspect (12) of this disclosure pertains to the vehicle interior system of any one of Aspects (1) through (11), wherein a headform impact to the cover material, from a headform made of aluminum with a mass of 6.68 kilograms and where the headform impacts the cover material at 5.36 meters per second, results in a maximum headform displacement of greater than 30 millimeters.

Aspect (13) of this disclosure pertains to a module for a vehicle interior that is configured for attachment to a mechanical vehicle frame, the module comprising: a glass substrate; a frame comprising a first side and a second side, wherein the glass substrate is disposed on the first side of the frame; a support structure configured to attached the second side of the frame to the mechanical vehicle frame; wherein the support structure has a spring stiffness of no more than 5000 kN/m.

Aspect (14) of this disclosure pertains to the module of Aspect (13), wherein the support structure has a spring stiffness of at least 50 kN/m.

Aspect (15) of this disclosure pertains to the module of Aspect (13) or Aspect (14), wherein the support structure comprises a rectangular plate made from a ductile material, wherein the rectangular plate facilitates attachment of the frame to the mechanical vehicle frame.

Aspect (16) of this disclosure pertains to the module of Aspect (13) or Aspect (14), wherein the support structure comprises a hollow tube made from a ductile material, wherein the hollow tube facilitates attachment of the frame to the mechanical vehicle frame.

Aspect (17) of this disclosure pertains to the module of any one of Aspects (13) through (16), wherein the support structure further comprises at least one of a spring, a foam block, or a mounting rail.

Aspect (18) of this disclosure pertains to the module of any one of Aspects (13) through (17), wherein, when the module is attached to the mechanical vehicle frame, a headform impact to the glass substrate from a headform made of aluminum with a mass of 6.68 kilograms that impacts the glass substrate at 5.36 meters per second results in a maximum headform deceleration of less than 90 g.

Aspect (19) of this disclosure pertains to the module of any one of Aspects (13) through (18), wherein, when the module is attached to the mechanical vehicle frame, a headform impact to the glass substrate from a headform made of aluminum with a mass of 6.68 kilograms that impacts the glass substrate at 5.36 meters per second results in a stress of less than 900 MPa on the glass substrate.

Aspect (20) of this disclosure pertains to the module of any one of Aspects (13) through (19), further comprising a display mounted to the frame.

Aspect (21) of this disclosure pertains to a method of attaching a module to a mechanical vehicle frame, the module comprising a frame comprising a first side and a second side, wherein a glass substrate is disposed on the first side and a support structure is disposed on the second side, the method comprising the step of: connecting the support structure to the mechanical vehicle frame; wherein the support structure has a spring stiffness of no more than 5000 kN/m.

Aspect (22) of this disclosure pertains to the method of Aspect (21), wherein the support structure has a spring stiffness of at least 50 kN/m.

Aspect (23) of this disclosure pertains to the method of Aspect (21) or Aspect (22), wherein the support structure comprises a rectangular plate made from a ductile material, wherein the rectangular plate facilitates attachment of the frame to the mechanical vehicle frame.

Aspect (24) of this disclosure pertains to the method of Aspect (21) or Aspect (22), wherein the support structure comprises a hollow tube made from a ductile material, wherein the hollow tube facilitates attachment of the frame to the mechanical vehicle frame.

Aspect (25) of this disclosure pertains to the method of any one of Aspects (21) through (24), wherein the support structure further comprises at least one of a spring, a foam block, or a mounting rail.

Aspect (26) of this disclosure pertains to the method of any one of Aspects (21) through (25), wherein, when the module is attached to the mechanical vehicle frame, a headform impact to the glass substrate from a headform made of aluminum with a mass of 6.68 kilograms that impacts the glass substrate at 5.36 meters per second results in a maximum headform deceleration of less than 90 g.

Aspect (27) of this disclosure pertains to the method of any one of Aspects (21) through (26), wherein, when the module is attached to the mechanical vehicle frame, a headform impact to the glass substrate from a headform made of aluminum with a mass of 6.68 kilograms that impacts the glass substrate at 5.36 meters per second results in a stress of less than 900 MPa on the glass substrate.

Aspect (28) of this disclosure pertains to the method of any one of Aspects (21) through (27), further comprising a display mounted to the frame.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosed embodiments. No language in the specification should be construed as indicating any non-claimed element as essential.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A vehicle interior system comprising:
a back structure including one or more display devices for a vehicle user;
a transparent cover material attached to the back structure;
a collapsible energy-absorbing support for attaching the back structure to a frame of the vehicle, wherein the collapsible energy-absorbing support is configured to dissipate kinetic energy via plastic deformation, and wherein the collapsible energy-absorbing support comprises one of a hollow tube made from a ductile material, a thin-walled hollow tube, and a plate with a plate surface and a spring attached to the plate surface.

2. The vehicle interior system of claim 1, wherein the collapsible energy-absorbing support has a first end attached to the vehicle frame and a second end attached to the back structure, and wherein the distance from the first end to the second end ranges from one centimeter to 10 centimeters.

3. (canceled)

4. The vehicle interior system of claim 1, wherein the collapsible energy-absorbing support comprises a thin-walled hollow tube.

5. The vehicle interior system of claim 2, wherein the collapsible energy-absorbing support comprises a rectangular plate made from a ductile material, wherein the rectangular is formed into a shape that facilitates attachment to the back structure and vehicle frame.

6. (canceled)

7. The vehicle interior system of claim 1, wherein the collapsible energy-absorbing support is made from metal.

8. The vehicle interior system of claim 1, wherein the transparent cover material comprises a glass substrate.

9. (canceled)

10. The vehicle interior system of claim 1, wherein the back structure comprises one of a display, a touch panel, a circuit board, and a display frame.

11. The vehicle interior system of claim 1, wherein a headform impact to the cover material, from a headform made of aluminum with a mass of 6.68 kilograms and where the headform impacts the cover material at 5.36 meters per second, results in a maximum headform deceleration of less than 90 g.

12. The vehicle interior system of claim 1, wherein a headform impact to the cover material, from a headform made of aluminum with a mass of 6.68 kilograms and where the headform impacts the cover material at 5.36 meters per second, results in a maximum headform displacement of greater than 30 millimeters.

13. A module for a vehicle interior that is configured for attachment to a mechanical vehicle frame, the module comprising:
a glass substrate;
a frame comprising a first side and a second side, wherein the glass substrate is disposed on the first side of the frame;
a support structure configured to attached the second side of the frame to the mechanical vehicle frame;
wherein the support structure has a spring stiffness of no more than 5000 kN/m, and
wherein the support structure comprises one of
a hollow tube made from a ductile material,
a spring,
a foam block, and
a mounting rail.

14. The module of claim 13, wherein the support structure has a spring stiffness of at least 50 kN/m.

15. The module of claim 13, wherein the support structure comprises a rectangular plate made from a ductile material, wherein the rectangular plate facilitates attachment of the frame to the mechanical vehicle frame.

16. (canceled)

17. (canceled)

18. The module according to claim 13, wherein, when the module is attached to the mechanical vehicle frame, a headform impact to the glass substrate from a headform made of aluminum with a mass of 6.68 kilograms that impacts the glass substrate at 5.36 meters per second results in a maximum headform deceleration of less than 90 g.

19. The module according to claim 13, wherein, when the module is attached to the mechanical vehicle frame, a headform impact to the glass substrate from a headform made of aluminum with a mass of 6.68 kilograms that impacts the glass substrate at 5.36 meters per second results in a stress of less than 900 MPa on the glass substrate.

20. The module according to claim 13, further comprising a display mounted to the frame.

21. A method of attaching a module to a mechanical vehicle frame, the module comprising a frame comprising a first side and a second side, wherein a glass substrate is disposed on the first side and a support structure is disposed on the second side, the method comprising the step of:
connecting the support structure to the mechanical vehicle frame;
wherein the support structure has a spring stiffness of no more than 5000 kN/m, and
wherein the support structure comprises one of
a hollow tube made from a ductile material,
a spring,
a foam block, and
a mounting rail.

22. The method of claim 21, wherein the support structure has a spring stiffness of at least 50 kN/m.

23. (canceled)

24. (canceled)

25. (canceled)

26. The method according to claim 21, wherein, when the module is attached to the mechanical vehicle frame, a headform impact to the glass substrate from a headform made of aluminum with a mass of 6.68 kilograms that impacts the glass substrate at 5.36 meters per second results in a maximum headform deceleration of less than 90 g.

27. The method according to claim 21, wherein, when the module is attached to the mechanical vehicle frame, a headform impact to the glass substrate from a headform made of aluminum with a mass of 6.68 kilograms that impacts the glass substrate at 5.36 meters per second results in a stress of less than 900 MPa on the glass substrate.

28. The method according to claim 21, further comprising a display mounted to the frame.
